(19) United States
(12) Patent Application Publication
(10) Pub. No.: US 2006/0197965 A1
(43) Pub. Date: Sep. 7, 2006

(54) Digital copying apparatus with a smart fitting function and copy method thereof

(75) Inventor: Thomas Sheng, Hsinchu (TW)

Correspondence Address: BIRCH STEWART KOLASCH & BIRCH, PO BOX 747, FALLS CHURCH, VA, 22040-0747, US

(73) Assignee: A VISION INC.

(21) Appl. No.: 11/365,883

(22) Filed: Mar. 2, 2006

(30) Foreign Application Priority Data
Mar. 3, 2005 (TW) 094106384

(51) Int. Cl. G06K 15/02

(52) U.S. Cl. 358/1.2; 358/1.15

(57) ABSTRACT

In a digital copying apparatus with a smart fitting function, a scanning unit acquires a document image of a document to obtain a document image signal, a sheet size sensor senses a to-be-printed sheet placed in a sheet storage module and outputs a sheet size signal, and a control processing unit receives the document image signal and the sheet size signal and selectively executes auto-cropping, rotating, and/or scaling procedures according to the document image signal and the sheet size signal such that the processed document image signal fits to the sheet size signal. Then, a printing unit receives a printing signal coming from the control processing unit and prints a printed image on the to-be-printed sheet.

### BACKGROUND OF THE INVENTION

1. Field of the Invention

The invention relates to a digital copying apparatus with a smart fitting function and a copy method thereof, and more particularly to a digital copying apparatus capable of auto-cropping (pre-processing) an image obtained after a document is scanned, and scaling and rotating (post-processing) the image to fit the size of a to-be-printed sheet, and a copy method thereof

2. Description of the Related Art

A conventional analog copying apparatus usually has multiple trays for the purpose of satisfying the user's demands on copying originals with different sizes, such that the user can select one suitable tray for the execution of the sheet printing procedure. Because the multiple trays for storing multiple sheets with, for example, the B5-size, A4-size and A3-size, have to be provided, or even the sheets with the same size have to be placed in a transversal tray and a longitudinal tray, the copying apparatus has a huge dimension and thus occupies a relative large space.

In order to obtain the sizes of various to-be-printed sheets and various original documents, multiple sensors usually have to be mounted in the copying apparatus, which adversely increases the cost of the copying apparatus. In addition, if the user does not correctly place the original document in a proper region, the copying apparatus may select the to-be-printed sheet incorrectly, or the copy result may have some images, which are cut out.

Furthermore, some documents are printed with very small letters but very large top, bottom, left and right margins. Some users may hope to remove these margins in the copied sheet while enlarging the letters, but this cannot be achieved in the typical copying apparatus.

### SUMMARY OF THE INVENTION

It is therefore an object of the invention to provide a digital copying apparatus with a smart fitting function and a copy method thereof in order to satisfy the demand of the user on the operational convenience and the copy diversification.

To achieve the above-identified object, the invention provides a digital copying apparatus comprising a printing unit, a scanning unit, a sheet storage module, a sheet size sensor and a control processing unit. The scanning unit acquires a document image of a document to obtain a document image signal. The sheet storage module stores a to-be-printed sheet. The sheet size sensor mounted in the sheet storage module senses a sheet size of the to-be-printed sheet and outputs a sheet size signal. The control processing unit, which is electrically connected to the printing unit, the scanning unit and the sheet size sensor, receives the document image signal and the sheet size signal and executes the process of: (a) performing a pre-processing step comprising an auto-cropping procedure to process the document image into a pre-processed image signal corresponding to a pre-processed document image according to the document image signal, performing a first post-processing step to process the pre-processed image signal into a first image signal fitting to the to-be-printed sheet according to the sheet size signal, and processing the first image signal into a first printing signal corresponding to a first printed image; or (b) performing a second post-processing step to process the document image signal into a second image signal fitting to the to-be-printed sheet according to the sheet size signal, and processing the second image signal into a second printing signal corresponding to a second printed image. The printing unit receives the first printing signal or the second printing signal and prints the first printed image or the second printed image on the to-be-printed sheet.

The invention also provides a copy method for a digital copying apparatus. The method includes the steps of: acquiring a document image of a document to obtain a document image signal; sensing a sheet size of a to-be-printed sheet and outputting a sheet size signal; executing the process of: (a) performing a pre-processing step comprising an auto-cropping procedure to process the document image into a pre-processed image signal corresponding to a pre-processed document image according to the document image signal, performing a first post-processing step to process the pre-processed image signal into a first image signal fitting to the to-be-printed sheet according to the sheet size signal, and processing the first image signal into a first printing signal corresponding to a first printed image; or (b) performing a second post-processing step to process the document image signal into a second image signal fitting to the to-be-printed sheet according to the sheet size signal, and processing the second image signal into a second printing signal corresponding to a second printed image; and receiving the first printing signal or the second printing signal and printing the first printed image or the second printed image on the to-be-printed sheet.

Thus, the number of trays may be reduced, the dimension of the copying apparatus may be effectively reduced, and it is possible to provide diversified copy options and a convenient operation environment for the user.

### BRIEF DESCRIPTION OF THE DRAWINGS

FIG. 1 is a schematic illustration showing a digital copying apparatus of the invention.

FIG. 2 shows an example of a smart fitting function of the invention.

FIG. 3 shows another example of the smart fitting function of the invention.

### DETAILED DESCRIPTION OF THE INVENTION

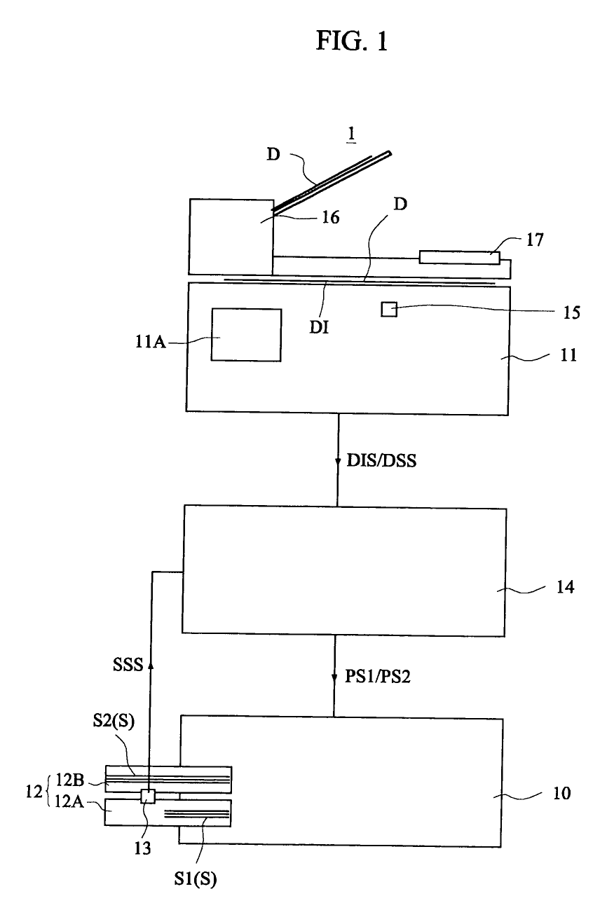

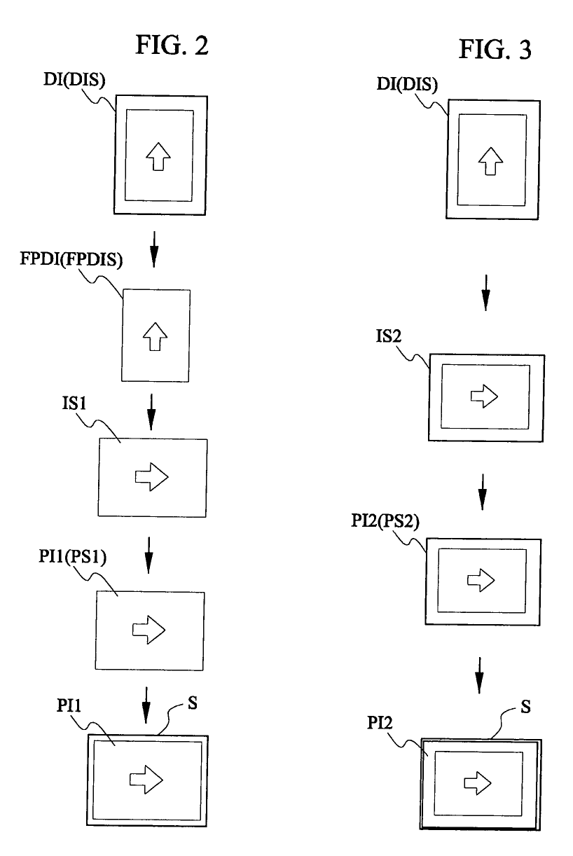

FIG. 1 is a schematic illustration showing a digital copying apparatus 1 of the invention. FIGS. 2 and 3 show examples of the smart fitting function of the invention. Referring to FIGS. 1 to 3, the digital copying apparatus 1 of the invention with the smart fitting function includes a printing unit 10, a scanning unit 11, a sheet storage module 12, a sheet size sensor 13 and a control processing unit 14.

The scanning unit 11 disposed beside the printing unit 10 acquires a document image DI of a document D to obtain a document image signal DIS. The sheet storage module 12 disposed beside the printing unit 10 stores a to-be-printed sheet S or a plurality of to-be-printed sheets S. The sheet size sensor 13 disposed in the sheet storage module 12 senses a sheet size of the to-be-printed sheet S and outputs a sheet size signal SSS corresponding to the sheet size of the to-be-printed sheet S. The control processing unit 14 electrically connected to the printing unit 10, the scanning unit 11 and the sheet size sensor 13 receives the document image signal DIS and the sheet size signal SSS, and then executes the process of:

(a) performing a pre-processing step comprising an auto-cropping procedure to process the document image DI into a pre-processed image signal FPDIS corresponding to a pre-processed document image FPDI according to the document image signal DIS, performing a first post-processing step to process the pre-processed image signal FPDIS into a first image signal IS1 fitting to the to-be-printed sheet S according to the sheet size signal SSS, and processing the first image signal IS1 into a first printing signal PS1 corresponding to a first printed image PI1, as shown in FIG. 2; and/or

(b) performing a second post-processing step to process the document image signal DIS into a second image signal IS2 fitting to the to-be-printed sheet S according to the sheet size signal SSS, and processing the second image signal IS2 into a second printing signal PS2 corresponding to a second printed image PI2, as shown in FIG. 3.

It is to be noted that the sheet size sensor 13 may be omitted from the apparatus 1. In this case, there is only one tray for storing the sheets S having only one fixed size, and the control processing unit 14 receives a sheet size signal corresponding to a sheet size of the to-be-printed sheet S. The sheet size signal may be previously stored in the copying apparatus 1.

The printing unit 10 receives the first printing signal PS1 or the second printing signal PS2 and prints the first printed image PI1 or the second printed image PI2 on the to-be-printed sheet S, as show in FIGS. 2 and 3.

The pre-processing step may further include a black-and-white/color recognizing procedure for enabling the printing unit 10 to execute a black-and-white/color printing operation to print the first printed image PI1 or the second printed image PI2 on the to-be-printed sheet S. For example, the pure black-and-white document may be adapted to a black-and-white printing mode, while the color document may be adapted to a color printing mode. Each of the first post-processing step and the second post-processing step may include a scaling procedure and an image rotating procedure.

In order to speed up the auto-cropping procedure, the auto-cropping procedure can be performed using a low-resolution image. Thus, the pre-processing step may further include, before the auto-cropping procedure, a low-resolution sampling procedure to obtain a low-resolution image signal, and thus to obtain cropping information for the auto-cropping procedure based on the low-resolution image signal. The cropping information usually corresponds to the dimension of the top, bottom, left and right margins to be cut out. In this example, the low-resolution sampling procedure is performed in the control processing unit 14.

Alternatively, the low-resolution sampling procedure may also be performed in the scanning unit 11. In this case, the scanning unit 11 may output the document image signal DIS and the low-resolution image signal, which is obtained after the low-resolution sampling procedure is performed to process the document image signal DIS, to the control processing unit 14, such that the control processing unit 14 obtains the cropping information for the auto-cropping procedure based on the low-resolution image signal.

In order to reduce the unnecessary movement of an optical module 11A of the scanning unit 11, the digital copying apparatus 1 may further include a document size sensor 15, which is electrically connected to the control processing unit 14 and senses a document size of the document D to obtain a document size signal DSS. Thus, the control processing unit 14 receives the document size signal DSS and controls the scanning unit 11 to acquire a scan range of the document D according to the document size signal DSS. For example, if the document D is only one half of the maximum scan range of the scanning unit 11 and the document D is close to the home position of the optical module 11A, it is unnecessary to move the optical module 11A throughout the maximum scan range. Instead, the optical module 11A may be moved back to the home position after the document D has been completely scanned. In this case, the control processing unit 14 further executes the pre-processing step, the first post-processing step or the second post-processing step according to the document size signal DSS so as to shorten the processing time.

In addition, the digital copying apparatus may further include an automatic sheet feeder 16 for feeding the document D.

The sheet storage module 12 of the invention may include only one tray, or two or more than two trays in order to diversify the copy results. For example, the sheet storage module 12 of this embodiment includes a first tray 12A for storing a first sheet S1 or first sheets S1 with a first sheet size, and a second tray 12B for storing a second sheet S2 or second sheets S2 with a second sheet size larger than the first sheet size.

The sheet size sensor 13 senses the first sheet size of the first sheet S1 and the second sheet size of the second sheet S2 to output a first sheet size signal SSS and a second sheet size signal SSS. The sheet size sensor 13 may be one element for simultaneously sensing the sheet sizes in the two trays, or two elements for respectively sensing the sheet sizes in the two trays.

The control processing unit 14 receives the first sheet size signal SSS and the second sheet size signal SSS, and compares a size of the pre-processed document image FPDI or the document image DI with the first sheet size and the second sheet size. For example, when the size of the pre-processed document image FPDI or the document image DI is smaller than or equal to the first sheet size, the control processing unit 14 selects the first sheet S1 as the to-be-printed sheet S and may decide whether the scaling/rotating procedure has to be performed. When the size of the pre-processed document image FPDI or the document image DI is larger than the first sheet size and smaller than or equal to the second sheet size, the control processing unit 14 selects the second sheet S2 as the to-be-printed sheet S and may decide whether the scaling/rotating procedure has to be preformed. When the size of the pre-processed document image FPDI or the document image DI is larger than the second sheet size, the control processing unit 14 selects the second sheet S2 as the to-be-printed sheet S and may decide whether the scaling/rotating procedure has to be performed.

Alternatively, the control processing unit 14 may receive a selection signal, which is inputted by a user through a user interface 17, to select the first sheet S1 or the second sheet S2 as the to-be-printed sheet S.

In addition to the above-mentioned digital copying apparatus, the invention also provides a copy method for a digital copying apparatus with the smart fitting function. The method has been described hereinabove, and detailed descriptions thereof will be omitted.

According to the digital copying apparatus of the invention, the number of trays may be decreased or even one tray has to be equipped for this apparatus. Thus, the dimension of the copying apparatus can be effectively reduced such that the copying apparatus becomes a desktop copying apparatus. In addition, the copying apparatus of the invention has the functions of auto-cropping, auto-scaling, auto-rotating (including de-skewing), and auto-identifying the black-and-white/color, and thus provides diversified options for the user. Furthermore, the numbers of the sheet size sensors and the document size sensors may be effectively reduced. Alternatively, the function of the invention may also be achieved using only one sheet size sensor but no document size sensor. According to the function of auto-cropping, no usefull image will be cut in the copy result even if the original document is arbitrarily placed on the scan platen.

While the invention has been described by way of examples and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A digital copying apparatus, comprising:
a printing unit;
a scanning unit for acquiring a document image of a document to obtain a document image signal;
a sheet storage module for storing a to-be-printed sheet; and
a control processing unit, which is electrically connected to the printing unit and the scanning unit, for receiving the document image signal and a sheet size signal corresponding to a sheet size of the to-be-printed sheet and executing the process of:
(a) performing a pre-processing step comprising an auto-cropping procedure to process the document image into a pre-processed image signal corresponding to a pre-processed document image according to the document image signal, performing a first post-processing step to process the pre-processed image signal into a first image signal fitting to the to-be-printed sheet according to the sheet size signal, and processing the first image signal into a first printing signal corresponding to a first printed image; or
(b) performing a second post-processing step to process the document image signal into a second image signal fitting to the to-be-printed sheet according to the sheet size signal, and processing the second image signal into a second printing signal corresponding to a second printed image;
wherein the printing unit receives the first printing signal or the second printing signal and prints the first printed image or the second printed image on the to-be-printed sheet.

2. The apparatus according to claim 1, further comprising:
a sheet size sensor, which is mounted in the sheet storage module and connected to the control processing unit, for sensing the sheet size of the to-be-printed sheet and outputting the sheet size signal.

3. The apparatus according to claim 2, further comprising:
a document size sensor, which is electrically connected to the control processing unit, for sensing a document size of the document to obtain a document size signal, such that the control processing unit receives the document size signal and controls a scan range of the scanning unit according to the document size signal.

4. The apparatus according to claim 3, wherein the control processing unit further executes the pre-processing step, the first post-processing step or the second post-processing step according to the document size signal.

5. The apparatus according to claim 2, further comprising:
an automatic sheet feeder for feeding the document.

6. The apparatus according to claim 2, wherein the sheet storage module comprises:
a first tray, in which a first sheet with a first sheet size is placed; and
a second tray, in which a second sheet with a second sheet size is placed, wherein the first sheet size is smaller than the second sheet size.

7. The apparatus according to claim 6, wherein the sheet size sensor senses the first sheet size of the first sheet and the second sheet size of the second sheet to output a first sheet size signal and a second sheet size signal.

8. The apparatus according to claim 7, wherein:
the control processing unit receives the first sheet size signal and the second sheet size signal and compares a size of the pre-processed document image or the document image with the first sheet size and the second sheet size;
when the size of the pre-processed document image or the document image is smaller than or equal to the first sheet size, the control processing unit selects the first sheet as the to-be-printed sheet;
when the size of the pre-processed document image or the document image is larger than the first sheet size and smaller than or equal to the second sheet size, the control processing unit selects the second sheet as the to-be-printed sheet; and
when the size of the pre-processed document image or the document image is larger than the second sheet size, the control processing unit selects the second sheet as the to-be-printed sheet.

9. The apparatus according to claim 6, wherein the control processing unit receives a selection signal, which is inputted by a user through a user interface, to select the first sheet or the second sheet as the to-be-printed sheet.

10. The apparatus according to claim 2, wherein the pre-processing step further comprises a black-and-white/color recognizing procedure for enabling the printing unit to execute a black-and-white/color printing operation to print the first printed image or the second printed image on the to-be-printed sheet.

11. The apparatus according to claim 2, wherein each of the first post-processing step and the second post-processing step comprises a scaling procedure and an image rotating procedure.

12. The apparatus according to claim 2, wherein the pre-processing step further comprises, before the auto-cropping procedure, a low-resolution sampling procedure to obtain a low-resolution image signal, and thus to obtain cropping information for the auto-cropping procedure based on the low-resolution image signal.

13. The apparatus according to claim 2, wherein the scanning unit outputs the document image signal and a low-resolution image signal, which is obtained after a low-resolution sampling procedure is performed to process the document image signal, to the control processing unit, such that the control processing unit obtains cropping information for the auto-cropping procedure based on the low-resolution image signal.

14. A copy method for a digital copying apparatus, the method comprising the steps of:
acquiring a document image of a document to obtain a document image signal;
executing the process of:
(a) performing a pre-processing step comprising an auto-cropping procedure to process the document image into a pre-processed image signal corresponding to a pre-processed document image according to the document image signal, performing a first post-processing step to process the pre-processed image signal into a first image signal fitting to the to-be-printed sheet according to a sheet size signal corresponding to a sheet size of a to-be-printed sheet, and processing the first image signal into a first printing signal corresponding to a first printed image; or
(b) performing a second post-processing step to process the document image signal into a second image signal fitting to the to-be-printed sheet according to the sheet size signal, and processing the second image signal into a second printing signal corresponding to a second printed image; and receiving the first printing signal or the second printing signal and printing the first printed image or the second printed image on the to-be-printed sheet.

15. The method according to claim 14, further comprising the steps of:
sensing the sheet size of the to-be-printed sheet and outputting the sheet size signal.

16. The method according to claim 15, further comprising the steps of:
sensing a document size of the document to obtain a document size signal; and
receiving the document size signal and controlling a scan range for acquiring the document according to the document size signal.

17. The method according to claim 16, further comprising the step of:
executing the pre-processing step, the first post-processing step or the second post-processing step according to the document size signal.

18. The method according to claim 15, wherein the pre-processing step further comprises a black-and-white/color recognizing procedure for enabling execution of a black-and-white/color printing operation to print the first printed image or the second printed image on the to-be-printed sheet.

19. The method according to claim 15, wherein each of the first post-processing step and the second post-processing step comprises a scaling procedure and an image rotating procedure.

20. The method according to claim 15, wherein the pre-processing step further comprises, before the auto-cropping procedure, a low-resolution sampling procedure to obtain a low-resolution image signal, and thus to obtain cropping information for the auto-cropping procedure based on the low-resolution image signal.
